(19) United States
(12) Patent Application Publication
(10) Pub. No.: US 2026/0122405 A1
(43) Pub. Date: Apr. 30, 2026

(54) EARPHONES

(71) Applicant: SHENZHEN SHOKZ CO., LTD., Shenzhen (CN)

(72) Inventors: Zhao XIE, Shenzhen (CN); Shuailin XIE, Shenzhen (CN)

(73) Assignee: SHENZHEN SHOKZ CO., LTD., Shenzhen (CN)

(21) Appl. No.: 19/433,838

(22) Filed: Dec. 28, 2025

Related U.S. Application Data
(63) Continuation of application No. PCT/CN2023/126055, filed on Oct. 23, 2023.

(51) Int. Cl. H04R 1/10; H04R 1/08

(52) U.S. Cl. CPC H04R 1/1075; H04R 1/083; H04R 1/105; H04R 1/1066; H04R 2410/07; H04R 2460/13

(57) ABSTRACT

The disclosure provides an earphone comprising: a housing assembly, a bone-conduction speaker, and an air-conduction speaker, the housing assembly including a first housing, a second housing, and a third housing, wherein the second housing is engaged with the first housing, the second housing and the first housing cooperate with each other to form a first accommodation cavity, the third housing is engaged with the first housing and the second housing, respectively, the third housing and the first housing cooperate with each other to form a second accommodation cavity; an air-conduction speaker disposed within the first accommodation cavity; and a bone-conduction speaker disposed within the second accommodation cavity, wherein the third housing is provided to contact a user's face in a wearing state, and an engagement seam between the third housing and the second housing does not contact the user's face.

### CROSS-REFERENCE TO RELATED APPLICATION

The application is a Continuation of International Application No. PCT/CN2023/126055 filed on Oct. 23, 2023, the contents of which are entirely incorporated herein by reference.

### TECHNICAL FIELD

This present disclosure relates to the technical field of electronic devices, and in particular to earphones.

### BACKGROUND

With the increasing proliferation of electronic devices, the electronic devices have become indispensable social and entertainment tools in people's daily lives, and people's requirements for the electronic devices are also increasing. The electronic devices (e.g., earphones, smart glasses) have also been widely used in people's daily life, which can be used in conjunction with terminal devices (e.g., mobile phones, computers, etc.) to provide users with an auditory feast.

However, an existing earphone housing is typically formed by assembling multiple components, which results in engagement seam(s) in a region where the earphone contacts with a user's face. Moreover, during daily use, the engagement seam(s) of the earphone housing may pinch the user's face, and sweat from the user's face may penetrate into an interior of the earphone through the engagement seam(s), thereby affecting electronic components inside the earphone.

### SUMMARY

To this end, the present disclosure provides an earphone can mitigate the issues in the prior art where the engagement seam(s) of the housing may pinch the user's face and allow sweat to enter the interior of the earphone during use.

The present disclosure provides an earphone comprising: a housing assembly, a bone-conduction speaker, and an air-conduction speaker, the housing assembly including a first housing, a second housing, and a third housing, wherein the second housing is engaged with the first housing, the second housing and the first housing cooperate with each other to form a first accommodation cavity, the third housing is engaged with the first housing and the second housing, respectively, the third housing and the first housing cooperate with each other to form a second accommodation cavity; an air-conduction speaker disposed within the first accommodation cavity; and a bone-conduction speaker disposed within the second accommodation cavity, wherein the third housing is provided to contact the user's face in a wearing state, and an engagement seam between the third housing and the second housing does not contact the user's face.

By controlling the engagement seam of the housing assembly not to contact the user's face, this design reduces the risk of the engagement seam of the housing assembly pinching the user's face. In addition, the risk of sweat from the user's face penetrating into the interior of the earphone through the engagement seam can also be minimized.

In some embodiments, the second housing and the first housing are engaged with each other, and the third housing is further engaged with the engaged first housing and the second housing.

In some embodiments, the third housing includes a main body portion and an extension portion, wherein the main body portion is configured to contact the user's face, the extension portion is integrally molded with the main body portion on a side of the main body portion close to the second housing, and the extension portion is engaged with the first housing and the second housing.

In some embodiments, the first housing includes a main housing and a first annular flange, the main housing includes a bottom wall portion and a side wall portion connected to each other, the first annular flange protrudes from an outer side of the side wall portion, and divided into a first sub-connecting portion and a second sub-connecting portion along a circumferential direction of the first annular flange; the second housing is engaged with the first annular flange, and is provided such that an outer peripheral surface of the second sub-connecting portion is exposed with respect to the second housing, and the third housing is engaged with the side wall portion and the second sub-connecting portion, and is disposed to cover the outer peripheral surface of the second sub-connecting portion and a portion of an outer side surface of the second housing.

In some embodiments, at an edge of the second housing close to the second sub-connecting portion, the outer side surface of the second housing is at least partially flush with the outer peripheral surface of the second sub-connecting portion.

In some embodiments, along the circumferential direction of the first annular flange, a ratio of a length of a portion of the second sub-connecting portion that is flush with the second housing to a length of the second sub-connecting portion is larger than 50%.

In some embodiments, along the circumferential direction of the first annular flange, a ratio of a length of the second sub-connecting portion to a length of the first annular flange is larger than ⅓.

In some embodiments, in a covered region where the third housing covers the second sub-connecting portion, the first housing and the third housing are respectively provided with first positioning structures that cooperate with each other.

In some embodiments, the first positioning structures include two positioning holes and two positioning posts that cooperate with each other; the two positioning holes are disposed on the outer peripheral surface of the second sub-connecting portion and spaced apart from each other, and a spacing direction of the two positioning holes intersects with an engaging direction of the first housing and the second housing; the two positioning posts are disposed on the third housing and interposed in the two positioning holes, respectively; and a glue accommodation groove is provided between the two positioning holes, and the glue accommodation groove extending in the spacing direction of the two positioning holes.

In some embodiments, in the covered region where the third housing covers the second housing, the second housing and the third housing are respectively provided with second positioning structures that cooperate with each other.

In some embodiments, the first positioning structures include two positioning holes and two positioning posts that cooperate with each other, wherein the two positioning holes are disposed on the outer peripheral surface of the second sub-connecting portion and spaced apart from each other, a spacing direction of the two positioning holes intersects with an engaging direction of the first housing and the second housing, and the two positioning posts are disposed on the third housing and interposed in the two positioning holes respectively; and the second positioning structures include an inset groove disposed on the portion of the outer side surface of the second housing and an inset block inset within the inset groove, wherein a length direction of the inset groove intersects with the engaging direction, and a projection of the inset groove along the engaging direction at least partially falls between the two positioning holes.

In some embodiments, the second housing is provided with a recessed region corresponding to a covered region of the third housing, and the third housing is inset in the recessed region.

In some embodiments, a depth of the recessed region is set such that an outer side surface of the third housing and the outer side surface of the second housing are flush with each other at the engagement seam between the third housing and the second housing.

In some embodiments, in the recessed region, the outer side surface of the second housing is inclined towards the bottom wall portion in a direction away from the second sub-connecting portion.

In some embodiments, the main housing and the first sub-connecting portion cooperate with each other to form a support table surface at an outer periphery of the first sub-connecting portion, and the second housing is supported on the support table surface and covers an outer peripheral surface of the first sub-connecting portion.

In some embodiments, the first sub-connecting portion is a protrusion, the second housing is provided with a slot corresponding to the first sub-connecting portion, and the first sub-connecting portion is clamped into the slot.

In some embodiments, the support table surface and the second housing are respectively provided with third positioning structures that cooperate with each other.

In some embodiments, the first housing is provided with an ear hook connection portion; and the bone-conduction speaker is closer to the ear hook connection portion with respect to the air-conduction speaker in a vibration direction of the air-conduction speaker.

In some embodiments, the support table surface is provided with a wiring hole that connects the second accommodation cavity to the outer periphery of the first sub-connecting portion, and the wiring hole is disposed adjacent to the ear hook connection portion.

In some embodiments, the first sub-connecting portion is provided with a wiring gap that is connected to the wiring hole.

In some embodiments, in a reference plane perpendicular to the vibration direction of the air-conduction speaker, a central axis of the ear hook connection portion has a first projection, the air-conduction speaker has a second projection, and a distance from the first projection to a center of the second projection is not larger than 5 millimeters (mm).

In some embodiments, the second housing abuts against an outer end surface of the second sub-connecting portion, and the outer end surface and/or an abutment surface between the second housing and the outer end surface are provided with a plurality of bumps spaced apart from each other.

In some embodiments, the second housing is provided with a second annular flange, and the second annular flange is inset on the first annular flange.

In some embodiments, the third housing has a planar contact region in contact the user's face in a use state, and in a normal direction of the planar contact region, a height difference between the planar contact region and the engagement seam is larger than 0.5 mm.

In some embodiments, the bone-conduction speaker has an upper end surface and a lower end surface that are oppositely disposed in a vibration direction of the bone-conduction speaker; and a central axis of the air-conduction speaker is located between the upper end surface and the lower end surface, and a ratio of a distance between the central axis of the air-conduction speaker and the upper end surface to a distance between the upper end surface and the lower end surface is within a range from 40% to 70%.

In some embodiments, the first housing includes a bottom wall portion, the bone-conduction speaker has a lower end surface adjacent to the bottom wall portion in a vibration direction of the bone-conduction speaker, and a gap between the bottom wall portion and the lower end surface increases along the a direction adjacent to the first accommodation cavity gradually to form an accommodation space for accommodating electronic components.

In some embodiments, the first housing is provided with an ear hook connection portion, and in a vibration direction of the air-conduction speaker, the bone-conduction speaker is closer to the ear hook connection portion with respect to the air-conduction speaker; the housing assembly is further provided with a pressure relief hole for connecting the first accommodation cavity to an external environment; and in a reference plane perpendicular to a vibration direction of the bone-conduction speaker, he bone-conduction speaker is in a shape of a rounded rectangle, and the pressure relief hole and the ear hook connection portion are disposed at rounded corner positions respectively located on opposite sides of a diagonal of the bone-conduction speaker.

### BRIEF DESCRIPTION OF THE DRAWINGS

In order to more clearly illustrate the technical solutions in the embodiments of the present disclosure, the accompanying drawings that need to be used in the description of the embodiments will be briefly introduced in the following. Obviously, the drawings in the following description are only some of the embodiments of the present disclosure, and for a person skilled in the art, other drawings can be obtained according to these drawings without creative labor.

FIG. 1 is a schematic diagram illustrating an overall structure of an exemplary earphone according to some embodiments of the present disclosure;

FIG. 2 is a schematic diagram illustrating an exemplary structure of a core assembly of an earphone according to some embodiments of the present disclosure;

FIG. 3 is a schematic diagram illustrating an exploded structure of a core assembly of an earphone according to some embodiments of the present disclosure;

FIG. 4 is a schematic diagram illustrating an anterior side contour of an ear of a user according to some embodiments of the present disclosure;

FIG. 5 is a schematic diagram illustrating an exemplary structure of a first housing of an earphone according to some embodiments of the present disclosure;

FIG. 6 is a schematic diagram illustrating an exemplary structure of a second housing of an earphone according to some embodiments of the present disclosure;

FIG. 7 is a schematic diagram illustrating an exemplary structure of a third housing of an earphone according to some embodiments of the present disclosure;

FIG. 8 is a schematic diagram illustrating an exemplary structure engaging a first housing and a second housing of an earphone are engaged according to some embodiments of the present disclosure;

FIG. 9 is a schematic diagram illustrating an exemplary structure that a first housing and a second housing of an earphone are engaged together according to some embodiments of the present disclosure;

FIG. 10 is a schematic diagram illustrating an exemplary structure engaging a third housing of an earphone with engaged first housing and second housing according to some embodiments of the present disclosure; and

FIG. 11 is a schematic diagram illustrating an exemplary structure of a microphone assembly of an earphone disposed in a first housing according to some embodiments of the present disclosure.

### DETAILED DESCRIPTION

The present disclosure is described in further detail below in conjunction with the accompanying drawings and embodiments. In particular, it is noted that the following embodiments are only used to illustrate the present disclosure, but do not limit the scope of the present disclosure. Similarly, the following embodiments are only part of the embodiments of the present disclosure rather than all of the embodiments, and all other embodiments obtained by a person of ordinary skill in the art without creative labor fall within the scope of protection of the present disclosure.

References to “embodiments” in the present disclosure imply that particular features, structures, or characteristics described in conjunction with the embodiments may be included in at least one embodiment of the present disclosure. It is understood by those persons skilled in the art, both explicitly and implicitly, that the embodiments described in this disclosure may be combined with other embodiments.

The inventors of the present disclosure have discovered that, in many existing core assemblies, a housing assembly is typically formed by assembling at least two housings. The location of engagement seam(s) formed during the assembly of the housings makes the engagement seam(s) susceptible to contacting a user's face during wearing. In this case, the engagement seam(s) may pinch the user's face, thereby reducing the wearing experience of the user. Moreover, due to the presence of the engagement seam(s), sweat from the user's face may penetrate into an interior of the housing assembly through the engagement seam(s), thereby further adversely affecting electronic components (e.g., a circuit board, a speaker, a microphone, etc.) inside the housing assembly.

In order to solve the above problem, some embodiments of the present disclosure provide an earphone 100a including core assemblies 1, ear hook assemblies 2, and a rear hook assembly 3.

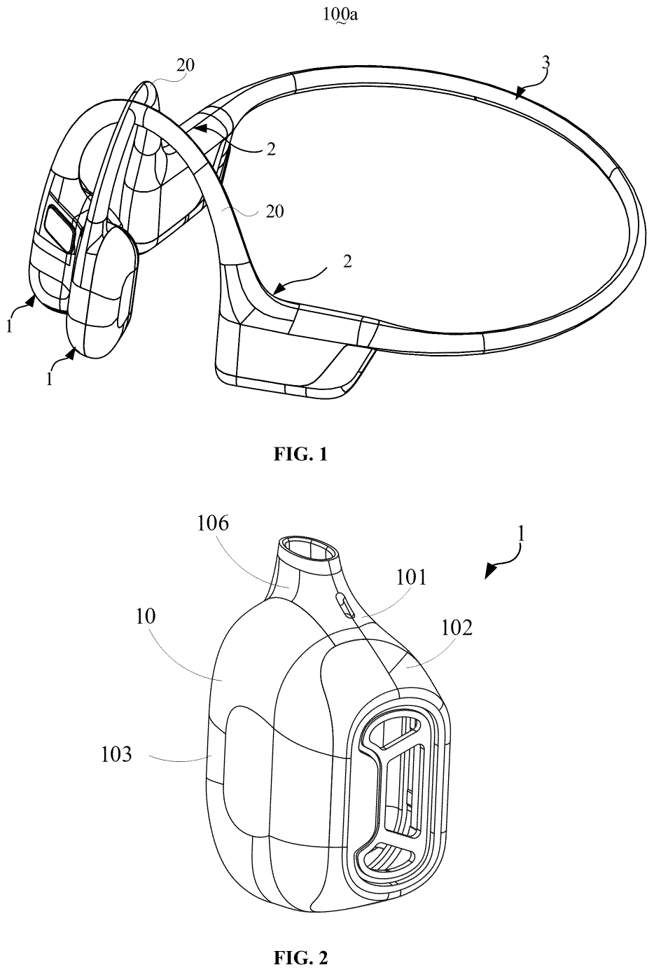

Referring to FIGS. 1-3, a count of the core assemblies 1 may be two. The two core assemblies 1 are configured to transmit vibrations and/or sound to left and right ears of a user, respectively. Each of the core assemblies 1 may include a housing assembly 10, a bone-conduction speaker 11, and an air-conduction speaker 12. The bone-conduction speaker 11 and the air-conduction speaker 12 may be disposed in the housing assembly 10. The air-conduction speaker 12 transmits the sound into the ear canal of the user through the air vibration principle, and the bone-conduction speaker 11 transmits the sound into the user through bone-conduction vibration. The two core assemblies 1 may be the same or different. For example, one core assembly 1 may be provided with a microphone, and the other core assembly 1 may not be provided with the microphone. As another example, one core assembly 1 may be provided with a key and a corresponding circuit board, and the other core assembly 1 may not be provided with the key and the corresponding circuit board. The two core assemblies 1 may have same core modules (e.g., a speaker module). As used herein, the following description of the core assembly 1 is provided by way of example, with reference to one of the two core assemblies 1 for purposes of detailed illustration.

A count of the ear hook assemblies 2 may be two, and the two ear hook assemblies 2 may be hung on the left and right ears of the user, respectively, so that the core assemblies 1 contact the user's face. Each of the two ear hook assemblies 2 may include an ear hook 20 hung on the corresponding ear of the user. One end of the ear hook assembly 2 is connected to the corresponding core assembly 1, and the other end of the ear hook assembly 2 is connected to the rear hook assembly 3. The two ear hook assemblies 2 may be the same or different. For example, one of the ear hook assemblies 2 may be provided with a battery, and the other ear hook assembly 2 may be provided with a circuit board, an antenna component, etc. The circuit board may be electrically connected to at least one of the battery, the bone-conduction speaker, the air-conduction speaker, the microphone, the antenna component, etc.

The rear hook assembly 3 connects the two ear hook assemblies 2, and the rear hook assembly 3 is used to wrap the back of the neck or the back of the brain of the user and provide a clamping force, so that the two core assemblies 1 are clamped to two sides of the user's face, and the ear hook assemblies 2 are hung on the ears of the user more stably. Of course, the earphone 100a may also not include the rear hook assembly 3, and the core assemblies 1 are worn in the ears of the user through the ear hook assemblies 2.

Referring to FIG. 4, the ear 500 of the user may include physiological parts, such as an external ear canal 501, a cavity of auricular concha 502, a cymba of auricular concha 503, a triangular fossa 504, an antihelix 505, a scapha 506, a helix 507, a tragus 508, a crus of helix 509, etc. Although the external ear canal 501 has a certain depth and extends to a tympanic membrane of the ear 500, for the convenience of description and in combination with FIG. 4, unless otherwise specified, the external ear canal 501 refers to an entrance (i.e., an aperture) of the external ear canal 501 that is away from the tympanic membrane in the present disclosure. Further, the physiological parts (e.g., the cavity of auricular concha 502, the cymba of auricular concha 503, the triangular fossa 504, etc.) have a certain volume and depth, and the cavity of auricular concha 502 is directly connected to the external ear canal 501, which can be simply regarded as that the aperture is located at a bottom of the cavity of auricular concha 502.

In some embodiments, wearing and stabilizing of the earphone 100a may be achieved by utilizing one or more parts of the ear 500. In some embodiments, the parts (e.g., the external ear canal 501, the cavity of auricular concha 502, the cymba of auricular concha 503, the triangular fossa 504, etc.) have the certain depth and volume in the three-dimensional space, which can be used to satisfy the wearing requirements of the earphone 100a.

Typically, the core assembly 1 is located on an anterior side of the ear in a wearing state, and the ear hook assembly 2 is located on the back side of the ear in the wearing state, so that the earphone 100a is hooked on the ear in the wearing state. The core assembly 1 may have a connection end that is connected to the ear hook assembly 2 and a free end that is not connected to the ear hook assembly 2. In some embodiments, the core assembly 1 may be configured to avoid blocking the external ear canal in the wearing state, enabling the earphone 100a to function as an “open-ear earphone.” Due to individual differences of different users, when the earphone 100a is worn by different users, the core assembly 1 may partially block the external ear canal, but the external ear canal remains unblocked.

In some embodiments, the open-ear earphone (e.g., the earphone 100a) may be worn with the aid of the cymba of auricular concha 503, the triangular fossa 504, the antihelix 505, the scaphoid fossa 506, the helix 507, or the like, or any combinations thereof, to wear the open-ear earphone. In some embodiments, to enhance wearing comfort and reliability of the earphone 100a, additional support may be provided by utilizing parts such as the earlobe of the user, etc. By utilizing parts of the ear 500 other than the external ear canal 501 for earphone wearing and sound transmission, the earphone 100a may “liberate” the external ear canal 501 of the user, thereby reducing the impact of the earphone 100a on the ear health of the user. When the user wears the earphone 100a on the road, the earphone 100a does not block the external ear canal 501 of the user, and the user can receive the sound from the earphone and sound from the environment (e.g., honks, bicycle bells, voices of nearby people, traffic commands, etc.), thereby reducing the probability of traffic accidents. For example, the whole or a portion of the structure of the earphone 100a may be located on the anterior side of the crus of helix 509 (e.g., a region J surrounded by dashed lines in FIG. 4) when the earphone 100a is worn by the user.

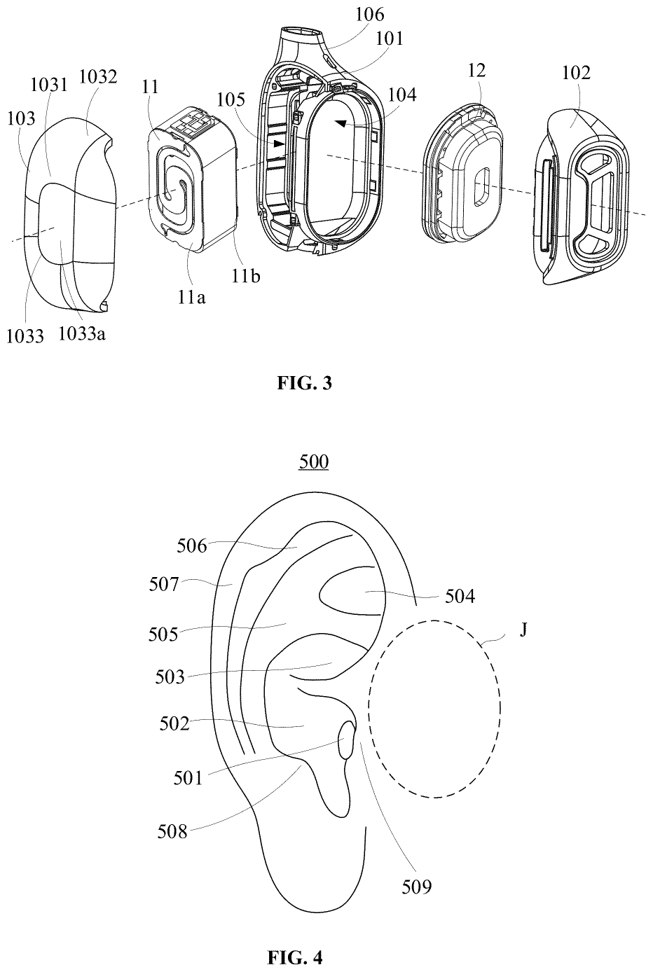

Additionally, there may be individual differences between different users, resulting in dimensional differences (e.g., different shapes, sizes, etc.) of ears. For the convenience of description and to reduce (or even eliminate) the individual differences between the users, a simulator (e.g., GRAS 45BC KEMAR) including a head and (left and right) ears of the head may be produced based on the ANSI: S3.36, S3.25 and IEC: 60318-7 standards. Therefore, in the present disclosure, embodiments such as “the user wears earphones,” “the earphones are in the wearing state,” “in the wearing state,” etc., may refer to the earphones of the present disclosure being worn on the ears of the simulator. Due to the individual differences between different users, there may be certain differences when the earphones are worn by different users and when the earphones are worn on the ears of the simulator, but the differences should be tolerated. According to one or more embodiments of the present disclosure, referring to FIG. 2 and FIG. 3, the core assembly 1 may include the housing assemblies 10, the bone-conduction speaker 11, and the air-conduction speaker 12. The air-conduction speaker 12 may transmit the sound into the ear canal of the user through the air vibration principle, and the bone-conduction speaker 11 may transmit the sound to the user through the bone-conduction vibration.

Referring to FIGS. 3 and 5-7, the housing assembly 10 may include a first housing 101, a second housing 102, and a third housing 103. The second housing 102 may be engaged with the first housing 101, the second housing 102 and the first housing 101 may cooperate with each other to form a first accommodation cavity 104. The third housing 103 is engaged with the first housing 101 and the second housing 102, respectively, and the third housing and the first housing cooperate with each other to form a second accommodation cavity 105. The air-conduction speaker 12 is provided within the first accommodation cavity 104. The bone-conduction speaker 11 is disposed within the second accommodation cavity 105. The third housing 103 is provided to contact the user's face in the wearing state, and an engagement seam between the third housing 103 and the second housing 102 does not contact the user's face.

That is, the housing assembly 10 (particularly the third housing 103) may have a contact region 1033 that contacts the user's face during wearing. The contact region 1033 may be a planar structure, a curved structure, or a combination of both. The engagement seam between the third housing 103 and the second housing 102 may be located outside of the contact region 1033. This configuration can control the engagement seam of the housing assembly 10 not to contact the user's face, thereby minimizing the risk of the engagement seam of the housing assembly 10 pinching the user's face, and enhancing the wearing comfort of the user. Additionally, the risk of sweat from the user's face penetrating into an interior of the housing assembly 10 through the engagement seam can be further minimized. It is noted that the contact region 1033 can be a portion of the earphone that contacts a facial region (region J) adjacent to the external ear canal 501 of the simulator when the earphone is worn in the aforementioned simulator.

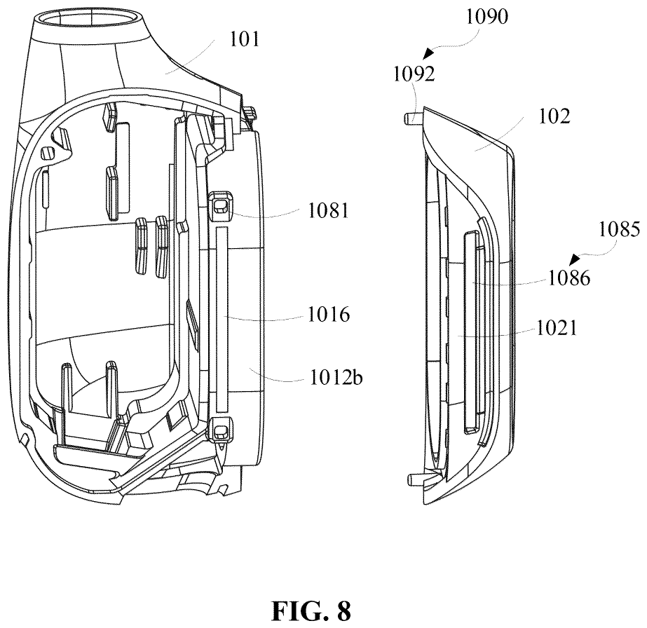

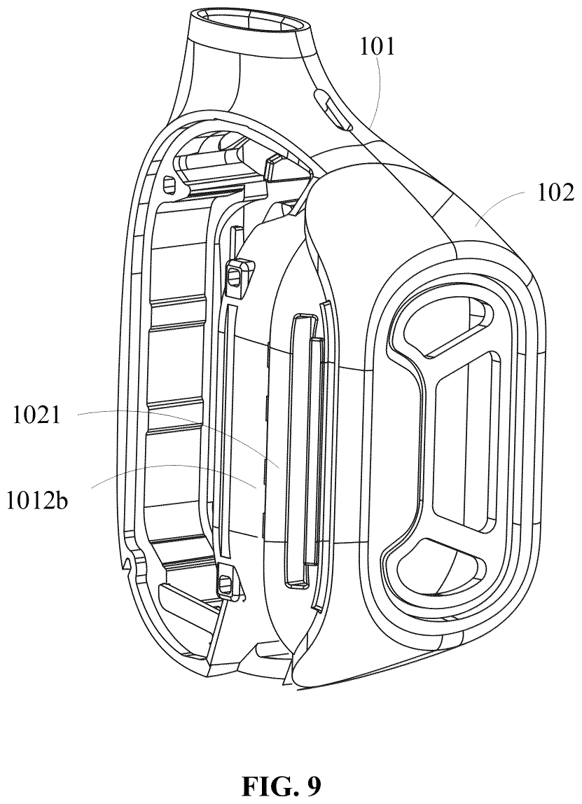

Referring to FIGS. 8-10, in some embodiments, the second housing 102 and the first housing 101 are engaged with each other. The third housing 103 is further engaged with the engaged first housing 101 and second housing 102. The first housing 101, the second housing 102, and the third housing 103 may be engaged by embedding or bonding. In this case, during an assembly process of the housing assembly 10, the first housing 101 and the second housing 102 may be docked and assembled first, and then the third housing 103 may be covered on the first housing 101 and the second housing 102 and assembled with the first housing 101 and the second housing 102, thereby reducing the difficulty of assembling the three housings. Of course, in other embodiments, the first housing 101 and the third housing 103 may be first engaged, and then the second housing 102 is engaged with the engaged first housing 101 and third housing 103. The present disclosure does not specifically limit the order that the three housings are engaged.

Referring to FIG. 3, in some embodiments, the third housing 103 includes a main body portion 1031 and an extension portion 1032. The main body portion 1031 is configured to contact the user's face. The extension portion 1032 is connected to the main body portion 1031. For example, the extension portion 1032 may extend from a side of the main body portion 1031 close to the second housing 102 toward a side back away from the user's face. In this case, the contact region 1033 may be formed in the main body portion 1031, and the extension portion 1032 may extend toward the side where the second housing 102 is located. In some embodiments, the extension portion 1032 is integrally molded with the main body portion 1031 on the side of the main body portion 1031 close to the second housing 102. The main body portion 1031 and the extension portion 1032 may be made of the same material, for example, integrally molded through injection molding using the same plastic. The first housing 101 and the second housing 102 are engaged with each other to form the engagement seam. The extension portion 1032 may extend to cover the first housing 101 and the second housing 102, and cover the engagement seam between the first housing 101 and the second housing 102. The extension portion 1032 may be further engaged with the first housing 101 and the second housing 102, thereby forming the engagement seam between the third housing 103 and the second housing 102 located at a space between the extension portion 1032 and the second housing 102. By covering the engagement seam between the second housing 102 and the first housing by the third housing 103, a count of exposed engagement seams can be further reduced, thereby reducing the workload of dispensing glue, and enabling a structure of the core assembly 1 more compact and reliable.

In this way, since the engagement seam between the first housing 101 and the second housing 102 is covered by the extension portion 1032 without being exposed, the overall sealing of the housing assembly 10 can be improved, the risk of the engagement seam of the housing assembly 10 pinching the user's face can be minimized, and the risk of sweat from the user's face penetrating into an interior of the housing assembly 10 through the engagement seam can be further minimized. Moreover, the count of exposed engagement seams of the housing assembly 10 that may contact the user's face can be reduced, thereby improving the wearing comfort.

In the structure where the engagement seam contact the user's face, the presence of the engagement seam may have a negative effect on the bone conduction of the sound. The third housing 103 in the present disclosure may have a relatively large surface area, so that an effective area of the bone conduction (i.e., a contact area between the third housing 103 and the user's face) may be increased when the bone-conduction speaker 11 is operating, thereby improving the effect of the bone conduction. In addition, an area of a housing portion (i.e., the third housing 103) of a side of the bone-conduction speaker 11 facing the user's face and an area of a housing portion (a portion of the first housing 101) of a side of the bone-conduction speaker 11 back away from the user's face are approximately equal, which improves a leakage sound cancellation effect of the bone-conduction speaker 11, thereby improving a leakage sound reduction effect.

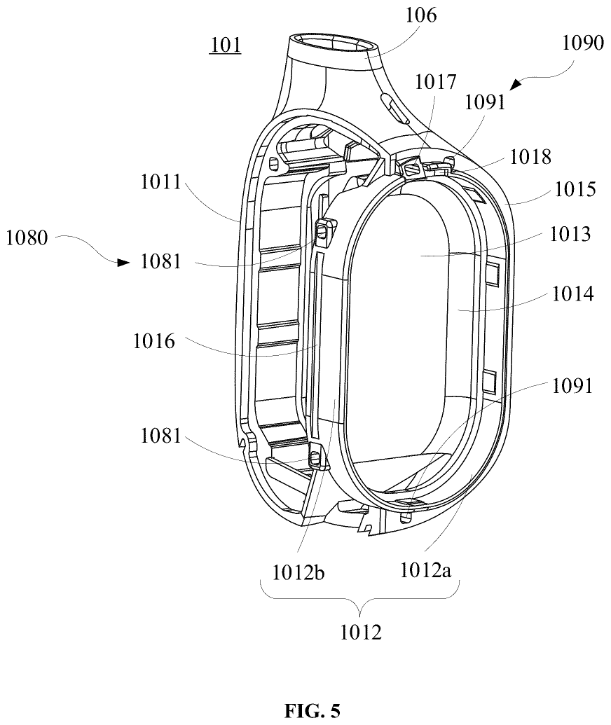

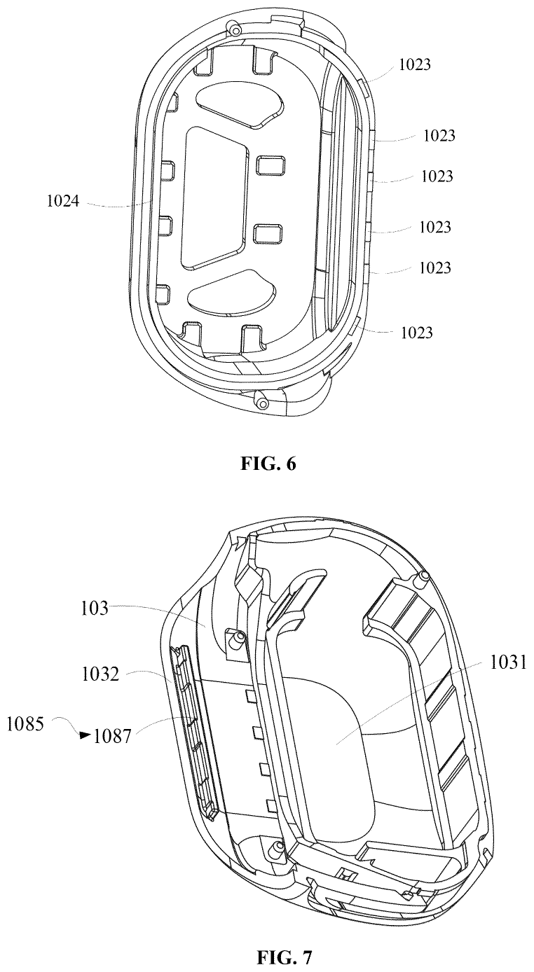

Referring to FIG. 5, in some embodiments, the first housing 101 includes a main housing 1011 and a first annular flange 1012. The main housing 1011 includes a bottom wall portion 1013 and a side wall portion 1014 connected to each other. The first annular flange 1012 protrudes from the outer side of the side wall portion 1014. The bottom wall portion 1013 may include a first bottom wall portion and a second bottom wall portion. The first bottom wall portion is a portion of the first housing 101 spaced apart from the second housing 102 when the first housing 101 and the second housing 102 are assembled, and the second bottom wall portion is a portion of the first housing 101 spaced apart from the third housing 103 when the first housing 101 and the third housing 103 are assembled. The side wall portion 1014 may include a first side wall portion and a second side wall portion. The first side wall portion is a portion of the side wall portion 1014 that is connected to an outer periphery of the first bottom wall portion and extends toward the second housing 102, and the second side wall portion is a portion of the side wall portion 1014 that is connected to an outer periphery of the second bottom wall portion and extends toward the third housing 103. In some embodiments, a surface of the side wall portion 1014 toward the second housing 102 may form a support table surface 1015 for supporting the second housing 102 when the first housing 101 and the second housing 102 are assembled. The first annular flange 1012 may protrude from the support table surface 1015.

Referring to FIG. 8 and FIG. 9, the second housing 102 may be configured to engage with the first annular flange 1012. In some embodiments, when the second housing 102 is engaged with the first housing 101, the first annular flange 1012 may be partially inset in the second housing 102. That is, the second housing 102 may surround a portion of the outer periphery of the first annular flange 1012. Another portion of the first annular flange 1012 may dock the second housing 102. For ease of description, the first annular flange 1012 may be divided into a first sub-connecting portion 1012a and a second sub-connecting portion 1012b along a circumferential direction of the first annular flange.

Referring to FIG. 5, in some embodiments, the main housing 1011 and the first sub-connecting portion 1012a cooperate with each other to form the support table surface 1015 at the outer periphery of the first sub-connecting portion 1012a. The second housing 102 is supported on the support table surface 1015 and covers the outer peripheral surface of the first sub-connecting portion 1012a. In this way, a contact area between the second housing 102 and the first housing 101 can be relatively large, thereby enhancing the reliability and bonding strength of the connection between the first housing 101 and the second housing 102. The second housing 102 may abut against the support table surface 1015. Alternatively, the second housing 102 and the support table surface 1015 may be further bonded to each other through an adhesive, such as glue, etc.

In some embodiments, the first sub-connecting portion 1012a may be a protrusion structure, and the second housing 102 is provided with a slot corresponding to the first sub-connecting portion 1012a. The first sub-connecting portion 1012a may be clamped into the slot. In this case, the first sub-connecting portion 1012a can be more reliably inset in the second housing 102. In some embodiments, the first sub-connecting portion 1012a may also be a recessed structure, and the second housing 102 may be provided with a protrusion structure fitting into the recessed structure, so that the first sub-connecting portion 1012a and the second housing 102 are reliably connected to each other through embedding. In some embodiments, the first sub-connecting portion 1012a may also be a combination of the protrusion structure and the recessed structure to enhance the reliability of the connection of the first sub-connecting portion 1012a and the second housing 102.

The second sub-connecting portion 1012b may refer to a portion of the first annular flange 1012 close to the third housing 103. The second housing 102 is provided such that an outer peripheral surface of the second sub-connecting portion 1012b is exposed with respect to the second housing 102. The third housing 103 is engaged with the side wall portion 1014 and the second sub-connecting portion 1012b, and the third housing 103 is disposed to cover the outer peripheral surface of the second sub-connecting portion 1012b and a portion of the outer side surface of the second housing 102. In this case, the third housing 103 and the second housing 102 may be combined to enclose the outer peripheral surface of the first annular flange 1012 of the first housing 101), with respect to directly using the second housing 102 to enclose the first annular flange 1012 and arranging the third housing 103 outside the second housing 102, this approach can reduce the thickness of the housing assembly 10 and the volume of the core assembly 1. And the engagement seam between the first housing 101 and the second housing 102 can be covered by the third housing 103 without being exposed, thereby improving the overall sealing of the housing assembly 10, reducing the risk of the engagement seam of the housing assembly 10 catching the user's face, and further reducing the risk of sweat from the user's face entering the interior of the housing assembly 10 through the engagement seam. And the count of exposed engagement seams of the housing assembly 10 that may come into contact the user's face can also be reduced, improving wearing comfort.

The first housing 101 and the second housing 102 are embedded with each other through structures such as the first sub-connecting portion 1012a and the support table surface 1015. The embedded structure can improve the connection strength when the first housing 101 and the second housing 102 are assembled. The second sub-connecting portion 1012b of the first housing 101 is docked to the second housing 102, and then the third housing 103 covers the first housing 101 and the second housing 102 by dispensing glue or a positioning structure. In this way, the second housing 102 and the second sub-connecting portion 1012b can realize a “unilateral fit”, thereby enabling the wall thickness of the housing assembly 10 to remain substantially uniform, and appropriately reducing the volume of the core assembly 1. Of course, after the first sub-connecting portion 1012a of the first housing 101 is engaged with the second housing 102, the first sub-connecting portion 1012a and the second housing 102 may also be connected through the dispensing glue to further enhance the reliability of the assembly. The “embed” refers to a configuration that at least three side surfaces of one component are enclosed by another component, and the “unilateral fit” refers to a configuration that one component docks another component through a single surface without an enclosing relationship.

In some embodiments, along the circumferential direction of the first annular flange 1012, a ratio of a length of the second sub-connecting portion 1012b to a length of the first annular flange 1012 is larger than ⅓. The ratio of the length of the second sub-connecting portion 1012b to the length of the first annular flange 1012 may be within a range from 33% to 35%, 35.01% to 40%, 40.01% to 45%, or 45.01% to 50%. For example, the ratio of the length of the second sub-connecting portion 1012b to the length of the first annular flange 1012 may be 34%, 37%, 38%, 41%, 42%, 43%, 46%, or 49%. In this case, the engagement seam between the third housing 103 and the first housing 101 can be as far away from the contact region 1033 as possible. In addition, the contact region during assembly of the third housing 103 and the first housing 101 can also be increased, thereby assembling the third housing 103 and the first housing 101 firmly.

In some embodiments, at an edge of the second housing 102 close to the second sub-connecting portion 1012b, the outer side surface of the second housing 102 is at least partially flush with an outer peripheral surface of the second sub-connecting portion 1012b. The outer side surface of the second housing 102 is at least partially flush with the outer peripheral surface of the second sub-connecting portion 1012b, which can reduce the risk of a gap between the third housing 103 and the outer side surface of the second housing 102 or the outer peripheral surface of the second sub-connecting portion 1012b, thereby facilitating the bone-conduction transmission and the reliable assembly of the third housing 103. In this case, after the third housing 103 is assembled, the gap between the third housing 103 and the outer side surface of the second housing 102 or the outer peripheral surface of the second sub-connecting portion 1012b can be reduced. Therefore, the structure of the core assembly 1 can be more compact, the stiffness of the housing assembly 10 after filling the glue can be larger, and the sound leakage reduction effect of the housing assembly 10 can be improved.

In some embodiments, along the circumferential direction of the first annular flange 1012, a ratio of a length of a portion of the second sub-connecting portion 1012b that is flush with the second housing 102 to a length of the second sub-connecting portion 1012b is larger than 50%. For example, the ratio of the length of the portion of the second sub-connecting portion 1012b that is flush with the second housing 102 to the length of the second sub-connecting portion 1012b may be 50%, 55%, 60%, 70%, 80%, etc. In this case, after the third housing 103 is assembled, the gap between the outer side surface of the third housing 103 and the second housing 102 or the outer peripheral surface of the second sub-connecting portion 1012b can be reduced, thereby improving the sound leakage reduction effect of the housing assembly 10.

Referring to FIG. 8 and FIG. 9, in some embodiments, the second housing 102 is provided with a recessed region 1021 corresponding to a covered region of the third housing 103, and the third housing 103 is inset in the recessed region 1021 to avoid the third housing 103 from protruding from the outer side surface of the second housing 102 when the third housing 103 and the second housing 102 are engaged, thereby making the core assembly 1 more compact.

In some embodiments, a depth of the recessed region 1021 is set such that the outer side surface of the third housing 103 and the outer side surface of the second housing 102 are flush with each other at the engagement seam between the third housing 103 and the second housing 102. That is, when the third housing 103 is assembled to the second housing 102, the outer side surface of the second housing 102 and the outer side surface of the third housing 103 can achieve a smooth transition at the connection, thereby improving the appearance of the core assembly 1. Moreover, the core assembly 1 can be more compact.

In some embodiments, in the recessed region 1021, the outer side surface of the second housing 102 is inclined towards the bottom wall portion 1013 in a direction away from the second sub-connecting portion 1012b. As a result, the engagement seam between the second housing 102 and the third housing 103 can be formed as far away from the contact region 1033 as possible, thereby reducing the likelihood of the engagement seam contacting the user's face.

In some embodiments, in a covered region where the third housing 103 covers the second sub-connecting portion 1012b, the first housing 101 and the third housing 103 are respectively provided with first positioning structures 1080 that cooperate with each other.

As a result, the stability degree when the first housing 101 and the third housing 103 are engaged can be further improved.

Referring to FIG. 5 and FIG. 10, in some embodiments, the first positioning structures 1080 include two positioning holes 1081 and two positioning posts 1082 that cooperate with each other. The two positioning holes 1081 are disposed on the outer peripheral surface of the second sub-connecting portion 1012b and spaced apart from each other, and a spacing direction of the two positioning holes 1081 intersects with an engaging direction of the first housing 101 and the second housing 102. The two positioning posts 1082 are disposed on the third housing103 and interposed in the two positioning holes 1081, respectively. In this case, an assembly accuracy of the first housing 101 and the third housing 103 can be improved, thereby reducing the probability of misalignment between the first housing 101 and the third housing 103 during the assembly or daily use. In some embodiments, the two positioning holes 1081 are spaced apart along an extension direction of the second sub-connecting portion 1012b. That is, the spacing direction of the two positioning holes 1081 is the extension direction of the second sub-connecting portion 1012b.

Referring to FIG. 5, in some embodiments, a glue accommodation groove 1016 is provided between the two positioning holes 1081, and the glue accommodation groove 1016 extends in the spacing direction of the two positioning holes 1081. When the first housing 101 and the third housing 103 are bonded together through the glue, the glue accommodation groove 1016 can further increase the bonding area of the glue, thereby enhancing the reliability of the assembly between the first housing 101 and the third housing 103. In some embodiments, the glue accommodation groove 1016 may be in a strip shape, which is more convenient for molding.

The embodiments described above involve disposing the two positioning posts 1082 on the third housing 103 and the two positioning holes 1081 on the second sub-connecting portion 1012b. However, in some embodiments, the positions of the two positioning posts 1082 and the two positioning holes 1081 may also be switched. For example, the two positioning posts 1082 may be disposed on the outer peripheral surface of the second sub-connecting portion 1012b, while the two positioning holes 1081 may be disposed on the third housing 103. Accordingly, the glue accommodation groove 1016 may be disposed between the two positioning posts 1082 or between the two positioning holes 1081. Alternatively, one positioning post 1082 and one positioning hole 1081 may be disposed on the outer peripheral surface of the second sub-connecting portion 1012b, and the correspondingly adapted positioning hole 1081 and positioning post 1082 may be disposed on the third housing 103. Accordingly, the glue accommodation groove 1016 may be disposed between the positioning post 1082 and the positioning hole 1081 on the second sub-connecting portion 1012b, which is not specifically limited herein.

Referring to FIGS. 7-9, in some embodiments, in the covered region where the third housing covers the second housing 102, the second housing 102 and the third housing 103 are respectively provided with second positioning structures 1085 that cooperate with each other. In such a case, an assembly accuracy between the second housing 102 and the third housing 103 can be improved, thereby reducing the probability of misalignment between the second housing 102 and the third housing 103 during the assembly or daily use.

In some embodiments, the second positioning structures 1085 include an inset groove 1086 disposed on the portion of the outer side surface of the second housing 102 and an inset block 1087 disposed within the third housing 103. The inset block 1087 may be inset within the inset groove 1086. A length direction of the inset groove 1086 (i.e., the extension direction of the inset groove 1086) intersects with the engaging direction of the first housing 101 and the second housing 102, and a projection of the inset groove 1086 along the engaging direction of the first housing 101 and the second housing 102 at least partially falls or located between the two positioning holes 1081. In some embodiments, both the inset groove 1086 and the inset block 1087 are in a strip shape, for example, an elongate strip shape or a rectangular strip shape. In this case, the assembly accuracy between the second housing 102 and the third housing 103 can be improved, thereby reducing the probability of misalignment between the second housing 102 and the third housing 103 during the assembly or daily use.

In some embodiments, the first positioning structures 1080 on the second sub-connecting portion 1012b and the second positioning structures 1085 on the second housing 102 are located on opposite sides of the engagement seam of the first housing 101 and the second housing 102, respectively.

Referring to FIG. 5 and FIG. 8, in some embodiments, the support table surface 1015 and the second housing 102 are respectively provided with third positioning structures 1090 that cooperate with each other. Therefore, the stability degree when the first housing 101 and the second housing 102 are engaged can be further improved. In some embodiments, the third positioning structures 1090 include a positioning groove 1091 disposed in the support table surface 1015 and a positioning protrusion 1092 disposed in the second housing 102, or the positioning groove 1091 disposed in the second housing 102 and the positioning protrusion 1092 disposed in the support table surface 1015. The positioning protrusion 1092 may be inset into the positioning groove 1091 when the first housing 101 and the second housing 102 are engaged. In other embodiments, the third positioning structures 1090 may also include other cooperation structures, e.g., a snap structure, a threaded structure, etc. The present disclosure does not limit the specific structure of the third positioning structures 1090.

In some embodiments, the first positioning structures 1080, the second positioning structures 1085, and the third positioning structures 1090 described above may be combined in any manner. That is, a two-by-two cooperation relationship of the first housing 101, the second housing 102, and the third housing 103 may include at least one of the first positioning structures 1080, the second positioning structures 1085, or the third positioning structures 1090. The present disclosure does not limit a specifical combination of the three positioning structures.

In some embodiments, the first housing 101 is provided with an ear hook connection portion 106 (referring to FIGS. 1-10). The bone-conduction speaker 11 is closer to the ear hook connection portion 106 with respect to the air-conduction speaker 12 in a vibration direction of the air-conduction speaker 12 (i.e., a distance between the bone-conduction speaker 11 and the ear hook connection portion 106 is larger than a distance between the air-conduction speaker 12 and the ear hook connection portion 106 in the vibration direction of the air-conduction speaker 12). In this case, shaking of the core assembly 1 can be reduced, thereby improving the wearing stability of the bone-conduction speaker 11 in scenarios (e.g., exercise), and enhancing sound quality. In some embodiments, the projection of the ear hook assembly 2 falls into the second accommodation cavity 105 in a projection direction parallel to the extension direction of the ear hook connection portion 106.

In some embodiments, the bone-conduction speaker 11 needs to be electrically connected to the control circuitry and a power source (e.g., the battery) via wires. By positioning the bone-conduction speaker 11 closer to the ear hook connection portion 106 with respect to the air-conduction speaker 12, the length of wires between the bone-conduction speaker 11 and the control circuitry as well as the power source can be reduced, thereby reducing the increase in resistance and the shaking of the core assembly 1 caused by excessively long wires, and reducing electrical connection problems caused by wire breakage or poor contact. Therefore, the reliability of the electrical connection can be improved.

In some embodiments, the air-conduction speaker 12 also needs to be electrically connected to the control circuitry and the power source via wires. The wires may further be threaded through the first housing 101 and the second housing 102 to supply power to the air-conduction speaker 12.

Referring to FIG. 5, in some embodiments, the support table surface 1015 of the first housing 101 is provided with a wiring hole 1017 that connects the second accommodation cavity 105 to the outer periphery of the first sub-connecting portion 1012a. In this case, the wire in the second accommodation cavity 105 may be threaded through the wiring hole 1017, and then enter the first accommodation cavity 104 and be connected to the air-conduction speaker 12. In some implementations, the wiring hole 1017 may be disposed adjacent to the ear hook connection portion 106. Therefore, a length of a wiring path of the wires can be further shortened, making the structure of the core assembly 1 more compact. In some embodiments, a section of the wiring hole 1017 is in a rectangular shape. Of course, in other embodiments, the wiring hole 1017 may be in other sectional shapes, which are not specifically limited herein.

In some embodiments, the first sub-connecting portion 1012a is provided with a wiring gap 1018 that is connected to the wiring hole 1017. The wiring gap 1018 may provide an avoidance space for the wires, facilitating the wires to be led out to the first accommodation cavity 104 for electrical connection to the air-conduction speaker 12.

In some embodiments, in a reference plane perpendicular to the vibration direction of the air-conduction speaker 12, a central axis of the ear hook connection portion 106 has a first projection, the air-conduction speaker 12 has a second projection, and a distance from the first projection to a center of the second projection is not larger than 5 mm, thereby making the structure of the core assembly 1 more compact. For example, the distance from the first projection to the center of the second projection may be 5 mm, 4 mm, 3 mm, 2 mm, 1 mm, or 0 mm. When the distance from the first projection to the center of the second projection is 0 mm (i.e., the center of the second projection passes through the first projection), the first accommodation cavity 104 and a vibration transmitting plate of the bone-conduction speaker 11 (the vibration transmitting plate of the bone-conduction speaker 11 is substantially perpendicular to the vibration direction of the bone-conduction speaker 11) are as a whole distributed in a T-shape. In this way, the overall volume of the core assembly 1 can be minimized and the structure can be most compact. It should be noted that the ear hook connection portion 106 has an opening which is used to connect the ear hook assembly 2, and a central axis of the ear hook connection portion 106 may pass through a center of the opening and be perpendicular to the plane where the opening is located.

In some embodiments, the housing assembly 10 is further provided with a pressure relief hole for connecting the first accommodation cavity 104 to the external environment. In a reference plane perpendicular to the vibration direction of the bone-conduction speaker, the bone-conduction speaker is in a shape of a rounded rectangle. The rounded rectangle may refer to a shape formed by chamfering right angles of a rectangle. In some embodiments, the pressure relief holes and the ear hook connection portion 106 are disposed at rounded corner positions respectively located on opposite sides of a diagonal of the bone-conduction speaker 11. In some embodiments, a center of the pressure relief hole and a center line of the wiring hole 1017 are provided at the diagonals of the bone-conduction speaker 11, respectively. In this case, the space at the rounded transitions of the housing assembly 10 can be fully utilized to dispose the pressure relief holes and the wiring holes 1017, thereby making the structure for the core assembly 1 more compact.

Referring to FIG. 6 and FIG. 7, in some embodiments, the second housing 102 abuts against the outer end surface of the second sub-connecting portion 1012b, and the outer end surface of the second sub-connecting portion 1012b and/or an abutment surface between the second housing 102 and the outer end surface are provided with a plurality of bumps 1023 spaced apart from each other. In this case, when the second housing 102 is bonded to the outer end surface of the second sub-connecting portion 1012b, the bumps 1023 can increase the bonding area, thereby increasing the bonding strength between the second housing 102 and the second sub-connecting portion 1012b.

In some embodiments, the second housing 102 is provided with a second annular flange 1024, and the second annular flange 1024 is inset on the first annular flange 1012. That is, the first annular flange 1012 may be disposed around an outer periphery of the second annular flange 1024. Alternatively, the second annular flange 1024 may be continuous or interrupted. In this case, the reliability of the connection between the first annular flange 1012 and the second annular flange 1024 can be further enhanced by embedding the first annular flange 1012 with the second annular flange 1024.

Referring to FIG. 3, in some embodiments, the third housing 103 has a planar contact region in contact with the user's face in a use state, and in a normal direction of the planar contact region, a height difference between the planar contact region and the engagement seam is larger than 0.5 mm. The planar contact region 1033a may be a planarized portion of the planar contact region 1033. In this case, the area of the extension portion 1032 can be appropriately increased without causing the area to be excessively large, thereby facilitating reliably and firmly assembling the third housing 103 onto the first housing 101 and the second housing 102, and reducing the probability of the third housing 103 falling off during the use.

In some embodiments, the bone-conduction speaker 11 has an upper end surface 11a and a lower end surface 11b that are oppositely disposed in the vibration direction of the bone-conduction speaker 11. The central axis of the air-conduction speaker 12 is located between the upper end surface 11a and the lower end surface 11b. The central axis of the air-conduction speaker 12 may be parallel to the vibration direction of the air-conduction speaker 12. This configuration can make the core assembly 1 more compact.

In some embodiments, a ratio of a distance between the central axis of the air-conduction speaker 12 and the upper end surface 11a of the bone-conduction speaker to a distance between the upper end surface 11a and the lower end surface 11b of the bone-conduction speaker is within a range from 40% to 70%. That is, compared to positioning the air-conduction speaker 12 close to the upper end surface 11a or the lower end surface 11b of the bone-conduction speaker 11, the air-conduction speaker 12 can be disposed close to the center of the bone-conduction speaker 11, thereby further reducing the size of the core assembly 1, and making the core assembly 1 more compact. In some embodiments, the ratio of the distance between the central axis of the air-conduction speaker 12 and the upper end surface 11a of the bone-conduction speaker 11 to the distance between the upper end surface 11a and the lower end surfaces 11b of the bone-conduction speaker 11 is 40%, 45%, 50%, 55%, 60%, 65%, 70%, etc. When the ratio of the distance between the central axis of the air-conduction speaker 12 and the upper end surface 11a of the bone-conduction speaker 11 to the distance between the upper end surface 11a and the lower end surface 11b of the bone-conduction speaker 11 is 50%, the first accommodation cavity 104 and the vibration transmitting plate of the bone-conducting loudspeaker 11 (the vibration transmitting plate of the bone-conduction speaker 11 is substantially perpendicular to the vibration direction of the bone-conduction speaker 11) are as a whole distributed in a T-shape. In this way, the overall volume of the core assembly 1 can be minimized and the structure can be most compact.

In some embodiments, the vibration direction of the bone-conduction speaker 11 is perpendicular to the central axis of the air-conduction speaker 12. In this case, the probability of interference between the bone-conduction speaker 11 and the air-conduction speaker 12 during the operation can be reduced.

As described above, the air-conduction speaker 12 intersects with the bone-conduction speaker 11. In general, the distance between the upper end surface 11a and the lower end surface 11b of the bone-conduction speaker 11 may be larger than a radial dimension of the air-conduction speaker 12 perpendicular to the central axis of the air-conduction speaker 12. Therefore, it is necessary to improve the structural shape of the housing assembly 10 to enhance the space utilization of the interior of the housing assembly 10.

In some embodiments, the bone-conduction speaker 11 has a lower end surface adjacent to the second bottom wall portion in the vibration direction of the bone-conduction speaker. A gap between the second bottom wall portion and the lower end surface increases along the direction adjacent to the first accommodation cavity 104 gradually to form an accommodation space for accommodating the electronic components. In this case, the space utilization of the interior of the housing assembly 10 can be improved, thereby making the structure of the core assembly 1 more compact.

In summary, the earphone 100a provided in some embodiments of the present disclosure may include the housing assembly 10, the bone-conduction speaker 11, and the air-conduction speaker 12. The housing assembly 10 may include the first housing 101, the second housing 102, and the third housing 103. The second housing 102 may be engaged with the first housing 101. The second housing 102 and the first housing 101 cooperate with each other to form the first accommodation cavity 104. The third housing 103 is engaged with the first housing 101 and the second housing 102, respectively, and the third housing 103 and the first housing 101 cooperate with the first housing 101 to form a second accommodation cavity 105. The air-conduction speaker 12 is disposed within the first accommodation cavity 104. The bone-conduction speaker 11 is disposed within the second accommodation cavity 105. The third housing 103 is provided to contact the user's face in the wearing state, and the engagement seam between the third housing 103 and the second housing 102 does not contact the user's face.

By controlling the engagement seam of the housing assembly 10 not to contact the user's face, the risk of the engagement seam of the housing assembly 10 pinching the user's face can be minimized. In addition, the risk of sweat from the user's face penetrating into the interior of the housing assembly 10 through the engagement seam can also be minimized.

Additionally, as described above, the core assembly 1 may include the housing assembly 10 and the microphone assembly 13. The housing assembly 10 may have a second accommodation cavity 105. The microphone assembly 13 may be disposed within the second accommodation cavity 105.

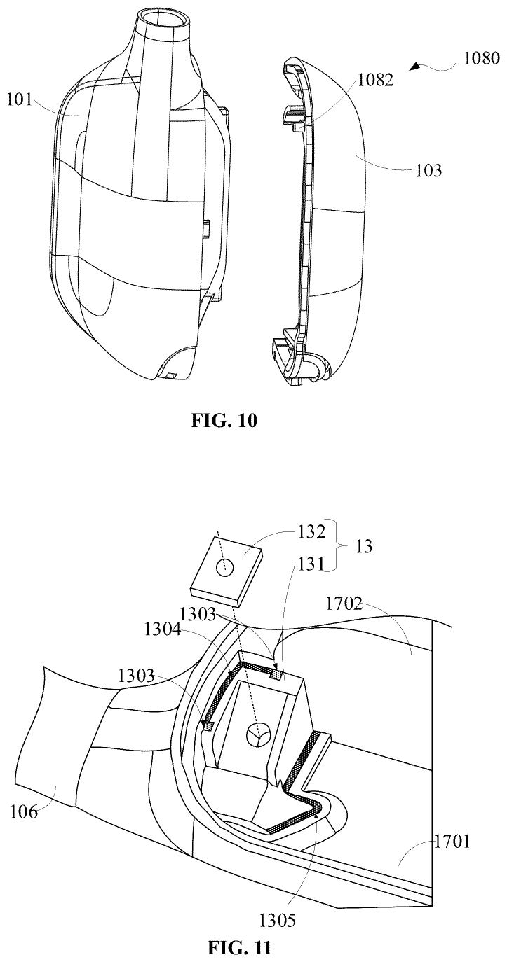

Referring to FIG. 11, in some embodiments, the housing assembly 10 is provided with one or two sound inlets (not shown). As shown in FIG. 11, the microphone assembly 13 may be used to capture external sound input through the sound inlet(s). Sound inlet ends of the two sound inlets may be spaced apart from each other, and sound outlet ends of the two sound inlets may be connected to each other. A sound inlet end of a sound inlet may refer to an end where the external sound enters the sound inlet. A sound outlet end of the sound inlet may refer to an end where the external sound flows out after passing through the sound inlet.

The microphone assembly 13 may include a support seat 131 and a microphone 132. The support seat 131 may be provided with a sound-conduction channel 1311. A sound inlet end of the sound-conduction channel 1311 is connected to the sound outlet ends of the two sound inlets. The microphone 132 may be disposed at a sound outlet end of the sound-conduction channel 1311. The sound inlet end of the sound-conduction channel 1311 may refer to an end of the sound-conduction channel where the external sound enters the sound-conduction channel after passing through the sound inlets. The sound outlet end of the sound-conduction channel 1311 may refer to an end where the external sound exits the sound-conduction channel 1311 through the sound inlets and the sound-conduction channel 1311.

In this case, the sound can enter the microphone assembly 13 within the second accommodation cavity 105 via the two sound inlets to improve the sound pickup of the microphone assembly 13. Additionally, when significant airflow enters the sound inlets along with the sound during the pickup, the airflow may enter the housing assembly 10 through one of the two sound inlets and exit through the other sound inlet, thereby reducing wind noise during the pickup.

In some embodiments, the sound-conduction channel 1311 is arranged in a curved shape. In this case, the length of the sound-conduction channel 1311 can be increased to reduce the speed of the airflow, thereby reducing the impact of the wind noise.

In some embodiments, the housing assembly 10 is provided with a support surface 1071 and an abutting surface 1072. A bottom surface of the support seat 131 may be supported on the support surface 1071, and a side surface of the support seat 131 may abut against the abutting surface 1072.

In some embodiments, a first sealant 1303, a second sealant 1304, and a third sealant 1305 may be disposed at a connection on the abutting surface 1072 and the side surface of the support seat 131. The first sealant 1303 may seal a gap between the side surface of the support seat 131 and the abutting surface. The second sealant 1304 may at least seal a gap between a top surface of the support seat 131 and the abutting surface 1072. The third sealant 1305 may seal a gap between the bottom surface of the support seat 131 and the support surface 1071. Therefore, the probability of moisture penetrating into the interior of the housing assembly 10 from the gaps between the support seat 131 and the support surface 1071, the abutting surface 1072, and the bottom surface 1312 can be reduced.

That is, the first sealant 1303, the second sealant 1304, and the third sealant 1305 may isolate the interior of the housing assembly 10 from the sound inlets/sound-conduction channel 1311, thereby reducing the probability of moisture within the sound inlets/sound-conduction channel 1311 penetrating into the interior of the housing assembly 10 and causing dampness to the electronic components (e.g., the microphone 132) inside the housing assembly 10.

The above descriptions are only a portion of embodiments of the present disclosure, and are not intended to limit the scope of the present disclosure. Any equivalent device or equivalent process transformed using the contents of the specification of the present disclosure and the accompanying drawings, or directly or indirectly applied in other related technical fields, are all included in the scope of the present disclosure.

1. An earphone, comprising:
a housing assembly including a first housing, a second housing, and a third housing, wherein
the second housing is engaged with the first housing,
the second housing and the first housing cooperate with each other to form a first accommodation cavity,
the third housing is engaged with the first housing and the second housing, respectively, and
the third housing and the first housing cooperate with each other to form a second accommodation cavity;
an air-conduction speaker disposed within the first accommodation cavity; and
a bone-conduction speaker disposed within the second accommodation cavity, wherein the third housing is provided to contact a user's face in a wearing state, and an engagement seam between the third housing and the second housing does not contact the user's face.

2. The earphone of claim 1, wherein the second housing and the first housing are engaged with each other, and the third housing is further engaged with the engaged first housing and second housing.

3. The earphone of claim 1, wherein the third housing includes a main body portion and an extension portion,
the main body portion is configured to contact the user's face,
the extension portion is integrally molded with the main body portion on a side of the main body portion close to the second housing, and
the extension portion is engaged with the first housing and the second housing.

4. The earphone of claim 1, wherein the first housing includes a main housing and a first annular flange,
the main housing includes a bottom wall portion and a side wall portion connected to each other,
the first annular flange protrudes from an outer side of the side wall portion, and divided into a first sub-connecting portion and a second sub-connecting portion along a circumferential direction of the first annular flange;
the second housing is engaged with the first annular flange, and is provided such that an outer peripheral surface of the second sub-connecting portion is exposed with respect to the second housing, and
the third housing is engaged with the side wall portion and the second sub-connecting portion, and is disposed to cover the outer peripheral surface of the second sub-connecting portion and a portion of an outer side surface of the second housing.

5. The earphone of claim 4, wherein at an edge of the second housing close to the second sub-connecting portion, the outer side surface of the second housing is at least partially flush with the outer peripheral surface of the second sub-connecting portion.

6. The earphone of claim 5, wherein along the circumferential direction of the first annular flange, a ratio of a length of a portion of the second sub-connecting portion that is flush with the second housing to a length of the second sub-connecting portion is larger than 50%.

7. The earphone of claim 4, wherein along the circumferential direction of the first annular flange, a ratio of a length of the second sub-connecting portion to a length of the first annular flange is larger than ⅓.

8. The earphone of claim 4, wherein in a covered region where the third housing covers the second sub-connecting portion, the first housing and the third housing are respectively provided with first positioning structures that cooperate with each other.

9-11. (canceled)

12. The earphone of claim 4, wherein the second housing is provided with a recessed region corresponding to a covered region of the third housing, and the third housing is inset in the recessed region.

13. The earphone of claim 12, wherein a depth of the recessed region is set such that an outer side surface of the third housing and the outer side surface of the second housing are flush with each other at the engagement seam between the third housing and the second housing.

14. The earphone of claim 12, wherein in the recessed region, the outer side surface of the second housing is inclined towards the bottom wall portion in a direction away from the second sub-connecting portion.

15. The earphone of claim 4, wherein the main housing and the first sub-connecting portion cooperate with each other to form a support table surface at an outer periphery of the first sub-connecting portion, and the second housing is supported on the support table surface and covers an outer peripheral surface of the first sub-connecting portion.

16. (canceled)

17. The earphone of claim 15, wherein the support table surface and the second housing are respectively provided with third positioning structures that cooperate with each other.

18. The earphone of claim 15, wherein the first housing is provided with an ear hook connection portion; and
the bone-conduction speaker is closer to the ear hook connection portion with respect to the air-conduction speaker in a vibration direction of the air-conduction speaker.

19-21. (canceled)

22. The earphone of claim 4, wherein the second housing abuts against an outer end surface of the second sub-connecting portion, and at least one of the outer end surface or an abutment surface between the second housing and the outer end surface are provided with a plurality of bumps spaced apart from each other.

23. The earphone of claim 4, wherein the second housing is provided with a second annular flange, and the second annular flange is inset on the first annular flange.

24. The earphone of claim 1, wherein the third housing has a planar contact region in contact the user's face in a use state, and
in a normal direction of the planar contact region, a height difference between the planar contact region and the engagement seam is larger than 0.5 mm.

25. The earphone of claim 4, wherein the bone-conduction speaker has an upper end surface and a lower end surface that are oppositely disposed in a vibration direction of the bone-conduction speaker; and
a central axis of the air-conduction speaker is located between the upper end surface and the lower end surface, and a ratio of a distance between the central axis of the air-conduction speaker and the upper end surface to a distance between the upper end surface and the lower end surface is within a range from 40% to 70%.

26. The earphone of claim 1, wherein
the first housing includes a bottom wall portion,
the bone-conduction speaker has a lower end surface adjacent to the bottom wall portion in a vibration direction of the bone-conduction speaker, and
a gap between the bottom wall portion and the lower end surface increases along a direction adjacent to the first accommodation cavity gradually to form an accommodation space for accommodating electronic components.

27. The earphone of claim 1, wherein the first housing is provided with an ear hook connection portion, and in a vibration direction of the air-conduction speaker, the bone-conduction speaker is closer to the ear hook connection portion with respect to the air-conduction speaker;
the housing assembly is further provided with a pressure relief hole for connecting the first accommodation cavity to an external environment; and
in a reference plane perpendicular to a vibration direction of the bone-conduction speaker, the bone-conduction speaker is in a shape of a rounded rectangle, and the pressure relief hole and the ear hook connection portion are disposed at rounded corner positions respectively located on opposite sides of a diagonal of the bone-conduction speaker.
